(19) United States
(12) Patent Application Publication
(10) Pub. No.: US 2014/0093118 A1
(43) Pub. Date: Apr. 3, 2014

(54) Recordable LED Fridge Magnet

(71) Applicant: Ning Zhang, Markham (CA)

(72) Inventor: Ning Zhang, Markham (CA)

(21) Appl. No.: 13/596,794

(22) Filed: Oct. 1, 2012

(51) Int. Cl. H04R 1/02

(52) U.S. Cl. 381/387

(57) ABSTRACT

This invention pertains to a recordable LED fridge magnet which can not only emit light and sound but also have the recording function. Designed with a casing cover for the recordable LED fridge magnet, there is a permanent magnet pad at the bottom. The electronic components, set between the casing cover and the bottom, are mounted on the printed circuit board. The electronic components comprises: laminated LED light, loudspeaker and electronic sound chip, microphone, play key, flash key and extended power outlet. The invention makes the conventional fridge magnet more functional and adds much more fun to cooking in the kitchen. It can also be used or developed as a voice memo on the fridge for grocery reminder. It is a great gift for every family to take home a recorded memorable moment captured at the sight-seeing spot. Most of all, it is reusable and recordable.

### TECHNICAL FIELD

This invention pertains to a recordable LED fridge magnet, which can not only emit light and sound but also can have recording function; it belongs to the scope of the everyday necessities.

### BACKGROUND

All the conventional magnets are mostly colorful decoration used as a memorandum note or advertising poster for a product or service and so on. There are many potential functions remaining unexplored.

The fridge magnet can have more functions to be developed; especially when combined with components of light, sound and recording, which will make the fridge magnet more attractive and bring more convenience to people in their daily life.

### CONTENT

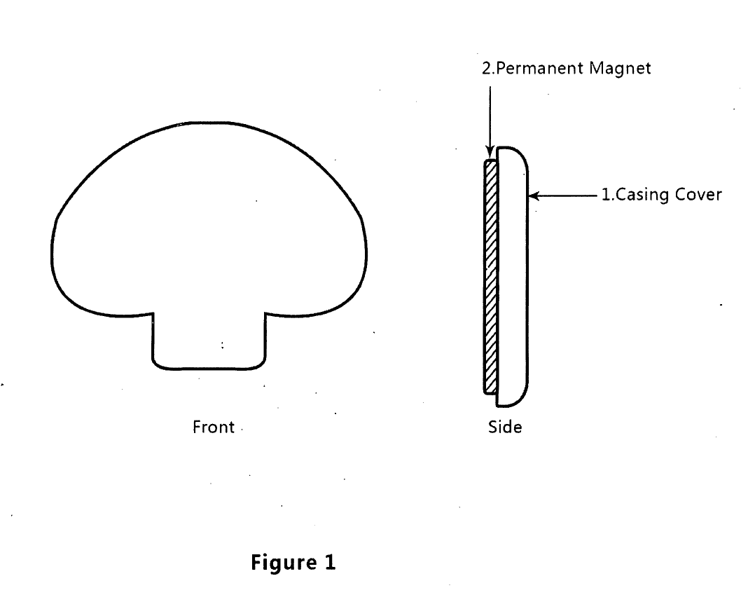

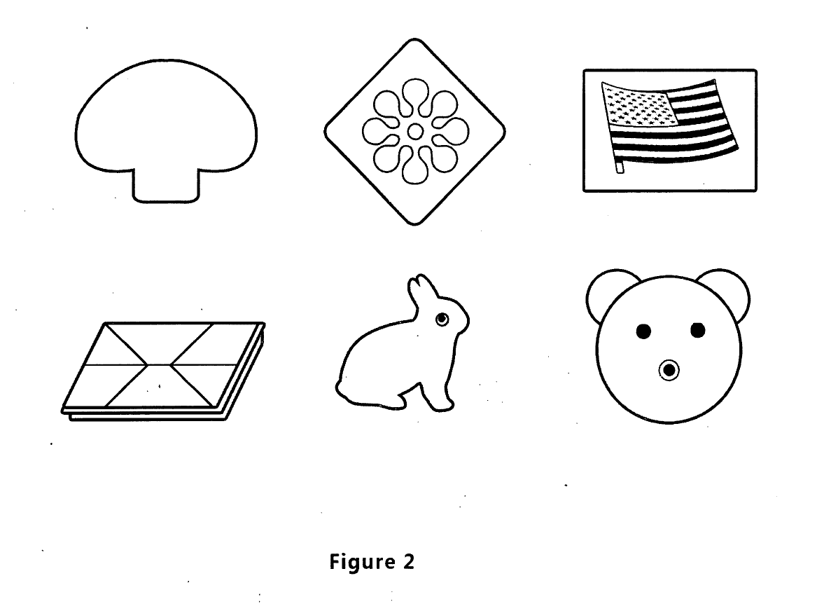

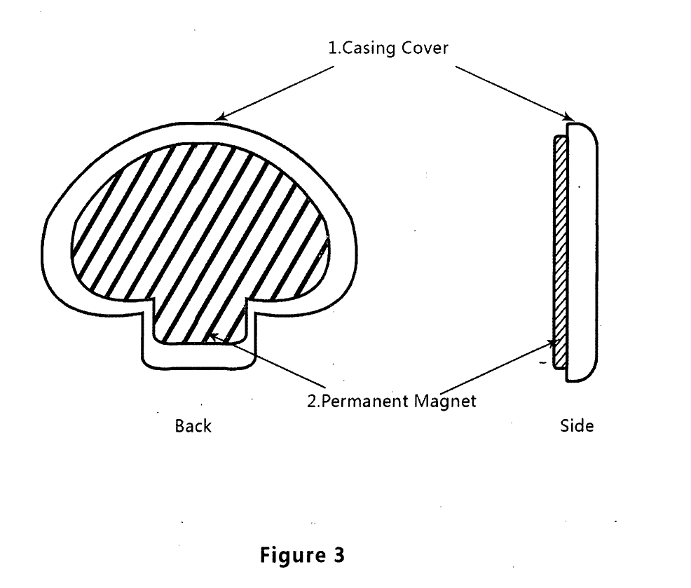

1. This invention pertains to a recordable LED fridge magnet which can not only emit light and sound but also can have the function of recording. The design has a casing cover for the recordable LED fridge magnet (FIG. 1), the shape of which can be various such as rectangle, diamond, round, trapezoid, animal or plant and so on (FIG. 2). The material, which needs to be very soft so that people can have better feeling when touching, generally is PVC or normal plastic. The material of the casing cover can be with or without printed designs and colors on it (FIG. 3). The casing cover is used to protect the electric components set inside the recordable LED fridge magnet.

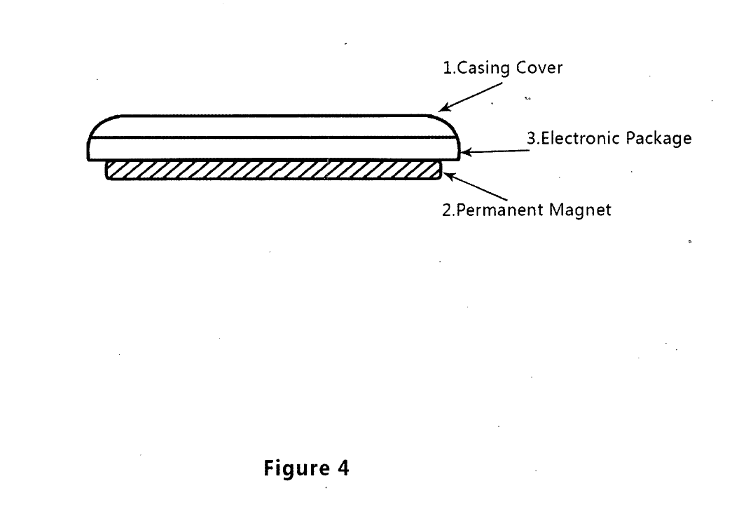

2. There is a permanent magnet pad at the bottom of the casing (FIG. 4), the material of permanent magnet pad is iron (can also be rubber magnet). The size of the permanent magnet pad is a little bit smaller than that of the casing. It can be embedded or glued to the bottom of the recordable LED fridge magnet. The permanent magnet pad attracts the recordable LED fridge magnet onto the fridge.

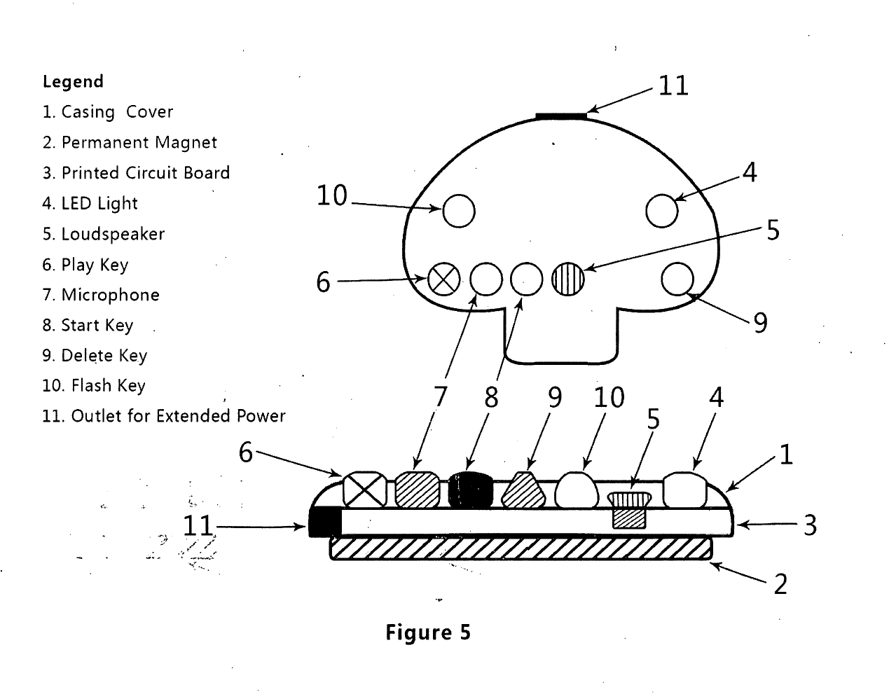

3. Between the casing cover and the bottom of the recordable LED fridge magnet are the electric components which are set on a printed circuit board (FIG. 5-3). These components set on the printed circuit board include laminated LED light (FIG. 5-4) which can be seen by means of being exposed from the cover of the recordable LED fridge magnet. LED light can be any color.

4. The components installed on the printed board include the loudspeaker or electronic sound chip (FIG. 5-5). The purpose of having a loudspeaker is to make the sound more closely to the original. The electronic sound chip can be replaced with a smaller size or low-cost one if it is not necessary to have sound closed to the original.

5. The microphone is set on the printed circuit board (FIG. 5-7); it is handy to record the sound of humans or the nature (for instance, the sound of surge or the recording of menus). The microphone is controlled by a start key (FIG. 5-8). The microphone will start recording when the button is pushed and it will stop recording when the button is released. The recording will be saved in the chip of printed circuit board, the recording time is around 5 minutes, but not limited to 5 minutes. There is a delete key on the printed circuit board that can be used when you want to remove the recorded message or sound (FIG. 5-9). The message can be deleted as long as the delete button is pushed continuously for around 30 seconds, but not limited to 30 seconds. There is also a play key (FIG. 5-6) on the printed circuit board. When the play key is pushed, the recorded sound is sent through the loudspeaker.

6. On the printed circuit board, there is a flash key (FIG. 5-10) which controls the laminated LED light. When flash key is pressed, the power will be connected and the laminated LED light will be on or start to flash. The flash key is also automatic time-delay switch which can be tuned off after around 30 seconds, but not limited to 30 seconds; can save battery power.

7. The power of the printed circuit board and the electronic components is supplied by the battery, but not limited to the pre-installed battery, set in the printed circuit board. The setting and changing the battery is conducted at the bottom of the recordable LED fridge magnet wherein there is an opening underneath. The recordable LED fridge magnet can also be connected to the external power supply through an outlet set on the side of the printed circuit board so that it can last longer time (FIG. 5-11).

### FIGURES

Attached FIG. 1:

Front and lateral view of the recordable LED fridge magnet which can not only emit light and sound but also have the recording function. FIG. 1-1 is the view of the cover of the recordable LED fridge magnet, FIG. 1-2 is the view of the permanent magnet pad at the back of the recordable LED fridge magnet.

Attached FIG. 2:

The view of different shapes, color and design of the recordable LED fridge magnet, it shows that more colors and designs can be made.

Attached FIG. 3:

The lateral view of the recordable LED fridge magnet which can emit light and sound but also can have the recording function. FIG. 3-1 shows the casing cover, FIG. 3-2 shows the permanent magnet pad at the back.

Attached FIG. 4:

The side view of the structure of the recordable LED fridge magnet which can not only emit light and sound but also have the recording function. FIG. 4-1 shows the cover; FIG. 4-2 shows the permanent magnet pad at the back; FIG. 4-3 is the electronic package including the electronic components and printed circuit board.

Attached FIG. 5:

The view of the structure of the recordable LED fridge magnet which can not only emit light and sound but also have the recording function. FIG. 5-1 shows the cover; FIG. 5-2 shows the permanent magnet pad at the back; FIG. 5-3 shows the printed circuit board; FIG. 5-4 shows the laminated LED light; FIG. 5-5 shows the loudspeaker; FIG. 5-6 shows the play key; FIG. 5-7 shows the microphone; FIG. 5-8 shows the key for starting to record; FIG. 5-9 shows the delete key; FIG. 5-10 shows the flash key; and FIG. 5-11 is the outlet for extended power.

### APPLICATION

Referring to the FIG. 5, the recordable LED fridge magnet is attached to the fridge by the permanent magnet pad at the back. If flash is required, push the flash key 10, the laminated LED light will be on and flashing. The laminated LED light will be off automatically after around 30 seconds, but not limited to 30 seconds, under the control of the automatic time-delay switch. When sound needs to be emitted, push the play key 6, the loudspeaker will start to work. If recording is required, push the recording key 8, put the microphone towards the direction of sound, recording will be processed. Recording time is around 5 minutes, but not limited to 5 minutes. If you want to delete the previous recording, push the delete key 9 continuously for around 30 seconds, but not limited to 30 seconds, and the recorded message or sound will be removed. If extended power is needed, just connect the extended power plug into an external outlet.

1. A kind of recordable LED fridge magnet, which can not only emit light and sound, but also have the recording function. The character lies in that: this design comprises a casing cover, on the back of which is a permanent magnet pad, inside of which is the printed circuit board. On the printed board are installed laminated LED light, loudspeaker or electronic sound chip, microphone, recording key, delete key, flash key, battery and outlet for connecting extended power line.

2. According to claim 1, the design of the shape for the casing cover can be various and the material of casing can be PVC or normal plastic.

3. According to claim 1, the back of the casing is glued with the permanent magnet pad. The shape of the permanent magnet pad matches with the casing.

4. According to claim 1, inside the casing is the printed circuit board on which the electronic components are installed.

5. According to claim 1, the electronic components installed on the printed circuit board include laminated LED light which can be any color.

6. According to claim 1, the loudspeaker and the electronic sound chip are set on the printed circuit board.

7. According to claim 1, the microphone, connected with the recording key or loudspeaker or sound chip, is set on the printed circuit board.

8. According to claim 1, the recording key, connected with the microphone, is set on the printed circuit board.

9. According to claim 1, the delete key, connected with the electronic memory card installed on the printed circuit board, is set on the printed circuit board.

10. According to claim 1, the flash key, connected with laminated LED light, is set on the printed circuit board.

11. According to claim 1, the battery and the line for extended power outlet are installed on the printed circuit board.
